(19) United States
(12) Patent Application Publication
(10) Pub. No.: US 2023/0224720 A1
(43) Pub. Date: Jul. 13, 2023

(54) CELLULAR TELECOMMUNICATIONS NETWORK

(71) Applicant: BRITISH TELECOMMUNICATIONS PUBLIC LIMITED COMPANY, London (GB)

(72) Inventor: Richard MACKENZIE, London (GB)

(21) Appl. No.: 18/002,148

(22) PCT Filed: May 11, 2021
(86) PCT No.: PCT/EP2021/062478

§ 371 Date: Dec. 16, 2022

(30) Foreign Application Priority Data
Jun. 18, 2020 (GB) 2009328.2

(51) Int. Cl. H04W 16/14; H04W 52/02

(52) U.S. Cl. CPC H04W 16/14; H04W 52/0206

(57) ABSTRACT

This disclosure provides a method in a cellular telecommunications network, wherein the cellular telecommunications network includes a first transceiver configured to provide a first access connection for a first mobile network operator in a first spectrum range and a second transceiver configured to provide a second access connection for a second mobile network operator in a second spectrum range, the method including determining that a condition for initiating spectrum sharing has been met, wherein the condition for initiating spectrum sharing is based on a capacity demand for the first mobile network operator exceeding a capacity available for the first mobile network operator and/or a peak rate demand for the first mobile network operator exceeding a maximum peak rate available for the first mobile network operator; in response to the determination, identifying a spectrum sharing solution in which: the first transceiver is configured to provide the first access connection for the first mobile network operator in the second spectrum range, and a capacity of the first access connection using the second spectrum range meets the capacity demand for the first mobile network operator; and reconfiguring the base station according to the identified spectrum sharing solution.

### PRIORITY CLAIM

The present application is a National Phase entry of PCT Application No. PCT/EP2021/062478, filed May 11, 2021, which claims priority from GB Patent Application No. 2009328.2, filed Jun. 18, 2020 each of which is hereby fully incorporated herein by reference.

### TECHNICAL FIELD

The present disclosure relates to a cellular telecommunications network.

### BACKGROUND

A cellular telecommunications network includes a base station providing voice and data services to a plurality of User Equipment (UE) via wireless communications. The base station is (at least in part) located at a cell site, which further includes supporting infrastructure (such as a power supply) for operating the base station. In traditional architectures, the cell site and base station are owned and operated by a single Mobile Network Operator (MNO) and the base station connects solely to that MNO's core network. The base station typically includes an antenna support (e.g. a mast, an antenna frame or rooftop attachment), one or more antennae and one or more controllers (e.g. a Radio Network Controller (RNC)).

There are several ways in which MNOs may cooperate to share infrastructure. The most basic example of shared MNO infrastructure, known as site sharing, is where the physical cell site is shared between MNOs but each MNO maintains ownership and control of the base station equipment (e.g. mast, antenna and controller). The base station supporting equipment (e.g. power supply) may or may not be shared between the MNOs in a site sharing arrangement. In a further example of shared MNO infrastructure, known as mast sharing, the base station's mast (or equivalent antenna support) is shared between MNOs, but each MNO maintains ownership and control of the remaining base station equipment (the antennae and controllers). Again, the base station supporting equipment (e.g. power supply) may or may not be shared between the MNOs in a mast sharing arrangement.

A more comprehensive form of shared MNO infrastructure is known as a Multi-Operator Radio Access Network (MORAN) in which the cell site, base station equipment and base station supporting equipment are shared between MNOs. The base station equipment must be configured to communicate with UEs of all MNOs, such as by transmitting each operator's Public Land Mobile Network (PLMN) identifier in the respective signals, but must communicate within each MNO's dedicated spectrum range. The base station equipment must also be configured to direct traffic to the appropriate MNO's core network. A similar arrangement is known as Multi-Operator Core Network (MOCN), in which the cell site, base station equipment and base station supporting equipment are again shared between MNOs and may also use shared spectrum ranges for communications with UEs of different MNOs.

A further alternative to shared infrastructure is where the cell site, base station and base station supporting equipment are owned and/or managed by a 3^{rd} party, and one or more MNOs operate on the 3^{rd} party's infrastructure. This is known as a “neutral host”.

A challenge in modern cellular telecommunications network is for MNOs to meet energy efficiency targets. These targets may create a downward pressure on the maximum capacity and coverage an MNO's base station may offer. To address this concern, energy saving mechanisms were introduced which allow a base station to enter an energy saving mode (where most if not all operations are suspended). To ensure continuity of service to UE previously served by the energy saving base station, the UE may be transferred to one or more neighboring base stations. The neighboring base station may alter its coverage area in order to provide service.

A further challenge in modern cellular telecommunications networks is to satisfy user demand for improved service, such as higher data rates, which are generally limited by the capacity of serving base station.

### SUMMARY

According to a first aspect of the disclosure, there is provided a method in a cellular telecommunications network, wherein the cellular telecommunications network includes a first transceiver configured to provide a first access connection for a first mobile network operator in a first spectrum range and a second transceiver configured to provide a second access connection for a second mobile network operator in a second spectrum range, the method comprising: determining that a condition for initiating spectrum sharing has been met, wherein the condition for initiating spectrum sharing is based on a capacity demand for the first mobile network operator exceeding a capacity available for the first mobile network operator and/or a peak rate demand for the first mobile network operator exceeding a maximum peak rate available for the first mobile network operator; in response to the determination, identifying a spectrum sharing solution in which: the first transceiver is configured to provide the first access connection for the first mobile network operator in the second spectrum range, and a capacity of the first access connection using the second spectrum range meets the capacity demand for the first mobile network operator; and reconfiguring the base station according to the identified spectrum sharing solution.

According to a second aspect of the disclosure, there is provided a computer program comprising instructions which, when the program is executed by a computer, cause the computer to carry out the method of the first aspect of the disclosure.

According to a third aspect of the disclosure, there is provided a network node having a processor configured to carry out the method of the first aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of an embodiment of a cellular telecommunications network of the present disclosure.

FIG. 2 is a flow diagram illustrating a first process implemented in a first embodiment of a method of the present disclosure.

FIG. 3 is a flow diagram illustrating a second process implemented in the first embodiment of a method of the present disclosure.

FIG. 4 is a schematic diagram of a cellular telecommunications network implementing the first embodiment of the method of the present disclosure, in a first configuration.

FIG. 5 is a schematic diagram of the cellular telecommunications network of FIG. 4, in a second configuration.

FIG. 6 is a flow diagram illustrating the first embodiment of the method of the present disclosure.

FIG. 7 is a schematic diagram of a cellular telecommunications network implementing the second embodiment of the method of the present disclosure, in a first configuration.

FIG. 8 is a schematic diagram of the cellular telecommunications network of FIG. 7, in a second configuration.

FIG. 9 is a flow diagram illustrating the second embodiment of the method of the present disclosure.

### DETAILED DESCRIPTION

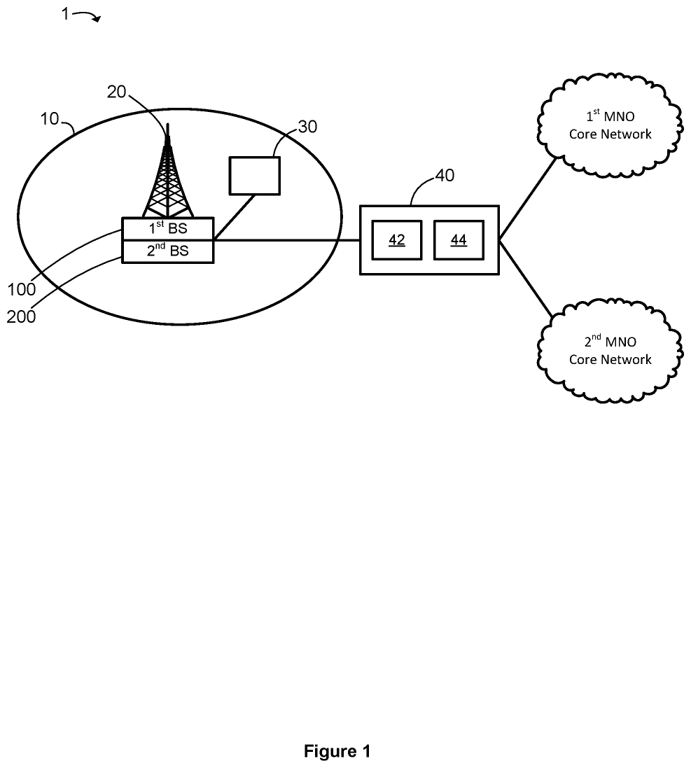

A first embodiment of a cellular telecommunications network 1 will now be described with reference to FIG. 1. FIG. 1 illustrates a cell site 10 including a mast 20 and base station support equipment 30 (shown as a single unit, but may comprise several components such as a power supply, cooling unit, etc.). The cell site 10, mast 20 and base station supporting equipment 30 are shared by a first Mobile Network Operator (MNO) and second MNO. The first MNO deploys a first base station 100 at the cell site, such that one or more transceivers are positioned on the mast 20 and any processing equipment is located in the cell site 10 (and may utilize the base station supporting equipment 30). The second MNO also deploys a second base station 200 at the cell site 10, such that one or more transceivers for the second base station 200 are positioned on the mast 20 and any processing equipment is located in the cell site 10 (again, this may utilize the base station supporting equipment 30). The processing equipment of the first and second base stations 100, 200 may operate on dedicated hardware, or may operate in virtualized environments on a common hardware platform.

FIG. 1 also illustrates a neutral host site 40. The neutral host site 40 has a transport connection with the first and second base stations 100, 200, a first backhaul connection with the core network of the first MNO and a second backhaul connection with the core network of the second MNO. These connections are typically optical fiber connections. The neutral host site 40 includes a controller 42 and router 44. The router 44 is responsible for routing traffic for the first base station 100 to/from the core network of the first MNO, and for routing traffic for the second base station 200 to/from the core network of the second MNO. The controller 42 is responsible for the management of shared operations at the cell site and for implementing embodiments of the method of the present disclosure (discussed below).

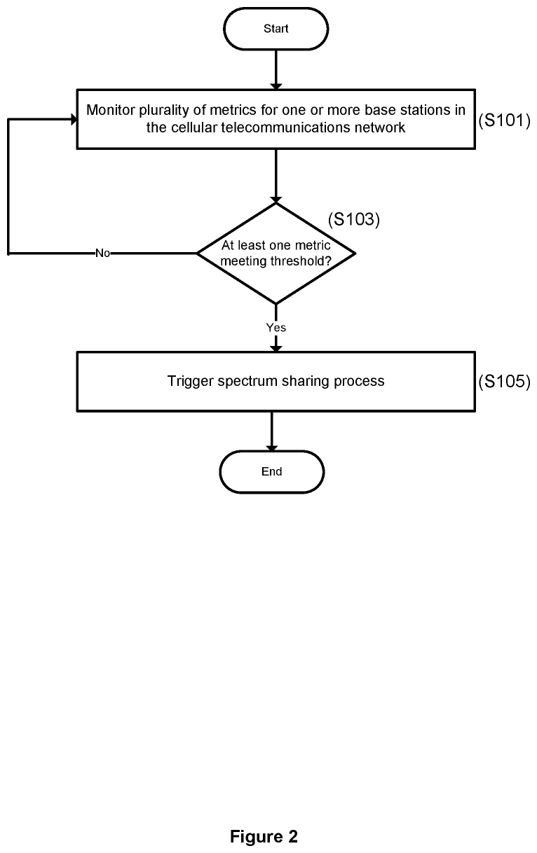

Before discussing the embodiments of the method of the present disclosure in more detail, an overview of two processes (used in these embodiments) will be described. A first process is an energy saving trigger mechanism. In S101 of this first process (as shown in FIG. 2), the neutral host controller 42 monitors a plurality of metrics for a plurality of base stations (including the first and second base stations 100, 200). These metrics include:
A measure of load, such as radio throughput as a proportion of radio capacity or the proportion of radio resources being used;
A measure of energy consumption (which may be converted to the equivalent measurement in units of carbon dioxide emissions);
A count of requests for increased service (e.g. increased data rate).

In S103, the neutral host controller 42 determines whether one or more of the plurality of metrics meet a threshold for initiating a spectrum sharing solution, such as:
1. the count of requests for increased service (for one or more of the plurality of base stations) exceeding a threshold,
2. a measure of load (for one or more of the plurality of base stations) exceeding a high load threshold indicating that spectrum sharing may be required to provide additional capacity,
3. a measure of load (for one or more of the plurality of base stations) exceeding a low load threshold indicating that the base station may enter energy saving mode,
4. a measure of energy consumption (for one or more of the plurality of base stations) an energy consumption threshold indicating that the base station has consumed too much energy and/or is responsible for too many units of carbon dioxide emissions (based on the MNO's energy targets).

If one or more of the plurality of metrics for a base station meet one of the above conditions indicating that it is desirable for that base station to enter energy saving mode (i.e. option 3 or option 4), then that base station is identified for inclusion as a potential energy saving base station in the second process (detailed below). If all performance metrics for a base station do not meet the relevant thresholds, then that base station is not identified as a potential energy saving base station in the second process.

Furthermore, in S105, if one or more of the plurality of metrics meet any one of these thresholds, then the second process is triggered to identify a spectrum sharing solution. If all metrics do not meet any of these thresholds, then the process ends without triggering the second process.

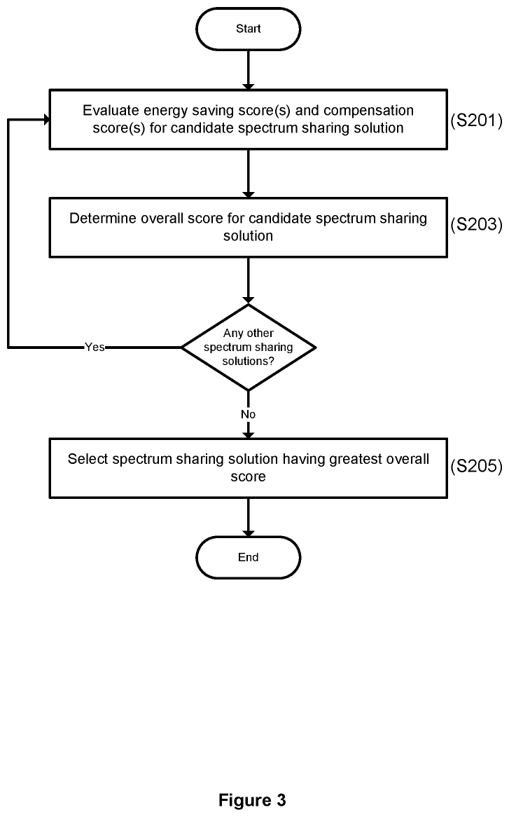

The second process for determining a suitable energy saving solution is shown in FIG. 3. In overview, the neutral host controller 42 identifies a plurality of candidate spectrum sharing solutions in which an MNO shares spectrum with another MNO. The neutral host controller 42 evaluates all possible variations of candidate spectrum sharing solutions in which at least one base station shares its spectrum with an MNO that does not use that spectrum (i.e. an MNO that is not one of the MNOs that currently have services provided on this spectrum) in order to fulfil a need for additional capacity for that other MNO. For example, a candidate spectrum sharing solution may involve the first base station (owned and operated by the first MNO) sharing its spectrum with the second MNO. The second MVO's overall capacity is then a sum of the capacities of the first base station 100 and second base station 200.

Furthermore, these candidate spectrum sharing solutions also include variations on energy saving modes, so as to find a solution that satisfies the need for additional capacity in an energy efficient manner. These solutions therefore include variations in which one or more of the base stations identified as potential energy saving base stations (in the first process) enter energy saving mode, and one or more of the other base stations in the cellular telecommunications network each act in energy saving mode, normal (active) mode, or compensation mode. For each candidate, the neutral host controller 42 evaluates a weighted score of a base station's suitability to enter energy saving mode (the “energy saving score”) for each base station entering energy saving mode in that candidate solution, a weighted score representing a base station's suitability to act in compensation mode (the “compensation score”) for each base station entering compensation mode in that candidate solution, and sums these energy saving and compensation scores to get an overall score for that candidate solution.

For example, the neutral host controller 42 may evaluate a first candidate spectrum sharing solution in which second base station 200 shares its spectrum with the first base station 100, the first base station 100 enters energy saving mode and the second base station 200 enters compensation mode. In S201, the neutral host controller 42 evaluates the energy saving score of the first base station 100 and the compensation score of the second base station 200. The energy saving score, ES, is evaluated as:

ESₙⁱ=Lₙⁱ*Dₙⁱ*(1−Cₙⁱ)

In which,
n is an identifier for the base station being evaluated for entering energy saving mode;
i is an identifier for the candidate solution being evaluated (as there may be different ES score for the same base station where there are several different candidate solutions);
L represents the load for base station n, normalized to a value between 0 and 1;
D represents the desirability for energy saving for base station n (discussed in more detail below), normalized to a value between 0 and 1; and
C represents the cost to users of base station n and users of each compensation base station when base station n is compensated for by the one or more compensation base stations of the candidate solution being evaluated (also discussed in more detail below), normalized to a value between 0 and 1.
   A weighting may be applied to each factor, L, D, and C, based on the MNO's policy.

The compensation score, Comp, is evaluated as:

Compₙⁱ=SCₙⁱ

In which,
n is an identifier for the base station being evaluated for entering compensation mode;
i is an identifier for the candidate solution being evaluated (as there may be different compensation score for the same base station where there are several different candidate solutions); and
SC represents the spare capacity of base station n, normalized between 0 and 1 (e.g. based on the total capacity of the base station).

In S203, the energy saving score(s) and compensation score(s) are summed to determine the overall score for the first candidate energy saving solution. The second process then loops back to S201 to evaluate the overall score for the remaining candidate energy saving solutions. The energy saving solution having the greatest overall score is then selected as the energy saving solution to be implemented (S205).

The desirability factor, D, is an evaluation of the benefits to the base station, n, based on the relevant MNO's policy, of entering energy saving mode. To perform this evaluation, the neutral host controller 42 stores, in memory, each MNO's policy for determining the desirability factor, and retrieves the relevant policy when evaluating the desirability factor for a base station. Each policy may be based on one or more the following:
The base station's measure of energy consumption relative to its energy consumption target; and/or
An estimate of the energy saved by base station n by entering energy saving mode in combination i, offset by the additional energy required by the one or more base stations entering compensation mode to compensate for the base station n entering energy saving mode.

The base station's measure of energy consumption may be based on units of energy or its equivalent in units of carbon dioxide emissions (based on the amount of carbon dioxide emitted for each unit of energy), relative to the MNO's target. The MNO's target may also be a cumulative target, e.g. over a month.

The cost factor represents any cost to users of the base station entering energy saving mode or to users of the one or more compensation base station(s). This may be a cost of degraded service experienced by users when being served by the compensation base station, or a cost incurred by the one of compensation base station(s) in order to compensate for the energy saving base station (such as the resources required to switch to MOCN mode if the energy saving base station and compensation base station are of different mobile network operators). Again, to perform this evaluation, the neutral host controller 42 stores, in memory, each MNO's policy for determining the cost factor, and retrieves the relevant policy when evaluating the cost factor for a base station. Each policy may be based on one or more of the following:
The services offered by the base station entering energy saving mode;
The service commitments of the base station entering energy saving mode; and
The ability for the base station(s) entering compensation mode to compensate for the services offerings/commitments of the base station entering energy saving mode.

The service offerings and commitments may be weighted so as to correlate with the relative cost for not providing a particular service. Service commitments may therefore be given greater weights than service offerings, as there may be more significant penalties for not providing a committed service. Furthermore, the base station entering compensation mode may provide improved service (e.g. more capacity to support increased data rates) than the base station entering energy saving mode. The cost factor may therefore be a negative value.

As noted above, there are a plurality of candidate spectrum sharing solutions available for any given arrangement, in which each base station may share its spectrum with another MNO and each base station operates in either energy saving, normal (active) or compensation mode. There may also be further solutions available in which:
a portion of the spectrum is shared with another MNO and/or is switched to energy saving or compensation mode,
a third base station shares its spectrum and/or is switched to energy saving or compensation mode,
each base station serves users according to a plurality of protocols and these services may independently share spectrum and/or be switched to energy saving or compensation mode, and/or
each base station uses multiple spectrum ranges (multiple “carriers”) for communications with UE and each carrier may independently share spectrum (or a portion thereof) and/or be switched to energy saving or compensation mode.

In scenarios where a base station provides a plurality of access options (e.g. via different protocols or different carriers), the first and second processes may perform their analyses on each of the plurality of access options. That is, the first process may analyze metrics for each access options to determine whether a spectrum sharing solution should be triggered and whether each access options is marked for entering energy saving mode, and the second process may analyze a plurality of candidate spectrum sharing solutions in which each access options is acting in either energy saving mode, normal (active) mode, or compensation mode.

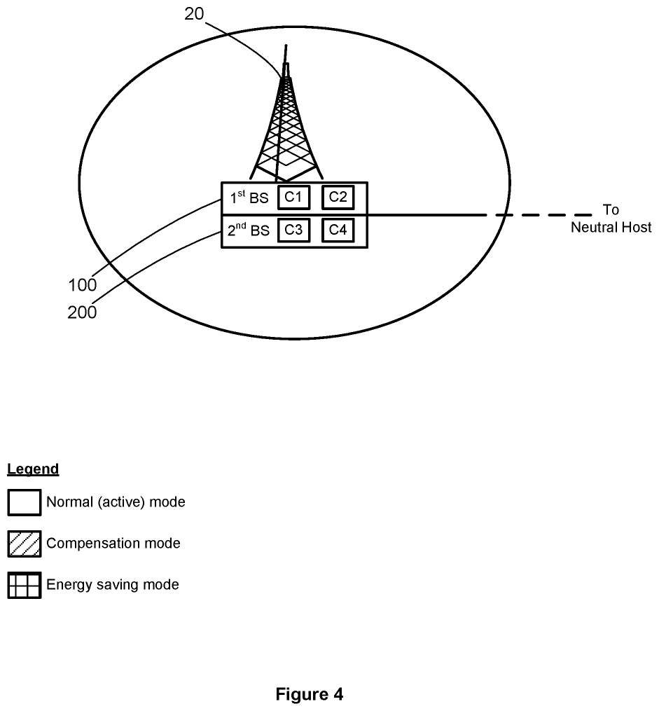

A first embodiment of a method of the present disclosure will now be described with reference to FIGS. 4 to 6. An initial state of the cellular telecommunications network is shown in FIG. 4, in which the cell site includes a first and second base station 100, 200 in a MORAN arrangement, in which the first base station 100 is operated by a first MNO and the second base station 200 is operated by a second MNO. The first base station 100 uses a first and second carrier (C1, C2) and the second base station 200 uses a third and fourth carrier (C3, C4). The first, second, third and fourth carriers are distinct, non-overlapping spectrum ranges for communications with UE.

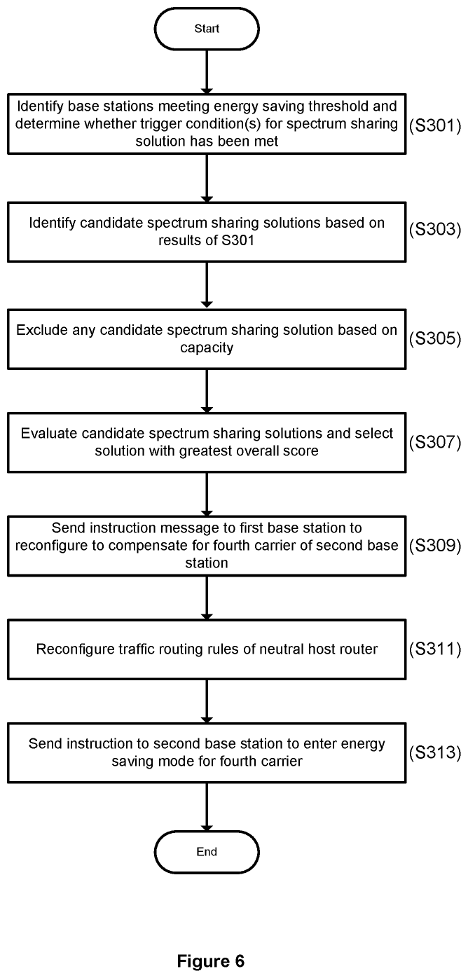

In S301 (as shown in the flow diagram of FIG. 6), the neutral host controller 42 performs the first process (as described above with reference to FIG. 2) to determine whether the one or more metrics for the first and/or second base station 100, 200 meet a threshold to be identified as an energy saving base station, and to determine whether the one or more metrics for the first and/or second base station 100, 200 meet a threshold for triggering a spectrum sharing solution. In this first embodiment, the most relevant metrics and thresholds for triggering a spectrum sharing solution are the first and second options listed above (a count of requests for increased service meeting a threshold and/or a load metric surpassing a high load threshold). The determination may be based on one or both of these metrics, or use weightings to be more heavily influenced by these metrics.

In this example, the neutral host controller 42 determines that a count of requests for increased service by UE of the fourth carrier of the second base station 200 has surpassed a threshold so as to trigger the second process for identifying a spectrum sharing solution. Furthermore, in this example, the one or more metrics for each carrier of the first and second base stations 100, 200 do not meet the threshold for being identified for entering energy saving mode.

In S303 of this first embodiment, the neutral host controller 42 identifies candidate spectrum sharing solutions. As noted above, the first and second carriers of the first base station 100 and third and fourth carriers of the second base station 200 may share their spectrum with another MNO (e.g. the first and/or second carrier of the first base station 100 may be shared with the second MNO, or the third and/or fourth carrier of the second base station 200 may be shared with the first MNO). Furthermore, each spectrum sharing solution may involve one or more carriers of one or more base stations using energy saving mode, normal (active) mode, or compensation mode in a candidate spectrum sharing solution. In this example, the first and second carriers of the first base station 100 and third and fourth carriers of the second base station 200 may be in either energy saving mode, normal (active) mode, or compensation mode. Spectrum sharing may be enabled independently of the carrier's energy saving/normal/compensation mode status, unless the carrier is compensating for a carrier of a different MNO that is entering energy saving mode.

In S305, the neutral host controller 42 evaluates the capacity available for each MNO for each candidate spectrum sharing solution. In an example candidate spectrum sharing solution, the first carrier of the first base station 100 shares its spectrum with the second MNO and all other carriers of the first base station 100 are in normal (active) mode, so the capacity available for the second MNO is the combined capacities of the first carrier of the first base station 100 and the third and fourth carriers of the second base station 200. These capacities are compared to a capacity demand for each MNO (in which, in this example, the capacity demand for the second MNO exceeds the current capacity availability). If the capacity demand for the first MNO exceeds (or is within a threshold, such as 90%, 95%, 99%, of) the capacity available for the first MNO in a candidate spectrum sharing solution (through both exclusive and shared spectrum), the capacity demand for the second MNO exceeds (or is within a threshold, such as 90%, 95%, 99% of) the capacity available for the second MNO in the candidate spectrum sharing solution (through both exclusive and shared spectrum), and/or the additional capacity demand (i.e. the capacity demand above that available through exclusive spectrum) for the first and second MNO exceeds (or is within a threshold, such as 90%, 95%, 99% of) the capacity available for the first and second MNOs through shared spectrum, then that candidate is excluded (and not considered in the remainder of the process).

In this embodiment, the neutral host controller 40 includes an admission control function which monitors the current demand of each carrier of each base station (based on, e.g. service requests from users). However, in alternative implementations, the base stations may monitor current demand for each carrier and report this to the neutral host controller 40.

In S307, the neutral host controller 42 performs the second process (as described above with reference to FIG. 3) in which the candidate spectrum sharing solutions are those which are not excluded in S305. In this example where there is a capacity demand for the second MNO which is greater than the current capacity availability of the third and fourth carriers of the second base station 200, the candidate spectrum sharing solutions which involve one or both of the first and second carriers of the first base station 100 being shared with the second MNO are not excluded in S305. However, candidate spectrum sharing solutions that involve either the first or second carrier of the first base station 100 being shared with the second MNO may have more favorable overall scores (compared to the solution involving both the first and second carrier of the first base station 100 being shared with the second MNO) based on the positive influence of the desirability factor indicating that a single carrier sharing solution is more energy efficient that a dual carrier sharing solution. The MNO policy may therefore balance the benefits of satisfying capacity demand with the benefits of energy saving by adjusting the respective weights in the scoring system.

In this example, the candidate spectrum sharing solution that receives the greatest overall score involves the fourth carrier of the second base station 200 entering energy saving mode, the first carrier of the first base station 100 entering compensation mode and compensating for the fourth carrier of the second base station 200, and the second carrier of the first base station 100 and the third carrier of the second base station 200 remaining in normal (active) mode. Although the fourth carrier of the second base station 100 entering energy saving mode reduces the capacity available for the second MNO (compared to a solution in which the first carrier of the first base station 100 and third and fourth carriers of the second base station 100 provide service for the second MNO), the positive influence of the desirability factor for the fourth carrier of the second base station 200 entering energy saving mode gives this solution a greater overall score.

In S309, the neutral host controller 42 sends an instruction message to the first base station 100 to cause the first base station 100 to reconfigure so that its first carrier compensates for the fourth carrier of the second base station 200. This includes a switch from the MORAN configuration to a MOCN configuration, in which the first base station 100 begins transmitting the first MNO's Public Land Mobile Network (PLMN) identifier (for transmissions between the first base station 100 and UE of the first MNO) and the second MVO's PLMN (for transmissions between the first base station and UE of the second MNO in order to compensate for the second base station's fourth carrier). The first base station 100 also accepts handovers and redirections of all users being served by the second base station's fourth carrier.

In S311, the neutral host controller 42 reconfigures the neutral host router so that any traffic for the second MNO's users now being served by the first base station 100 is routed between the first base station 100 and the second MNO's core network.

In S313, the neutral host controller 42 sends an instruction message to the second base station 200 to cause the second base station's fourth carrier to enter energy saving mode.

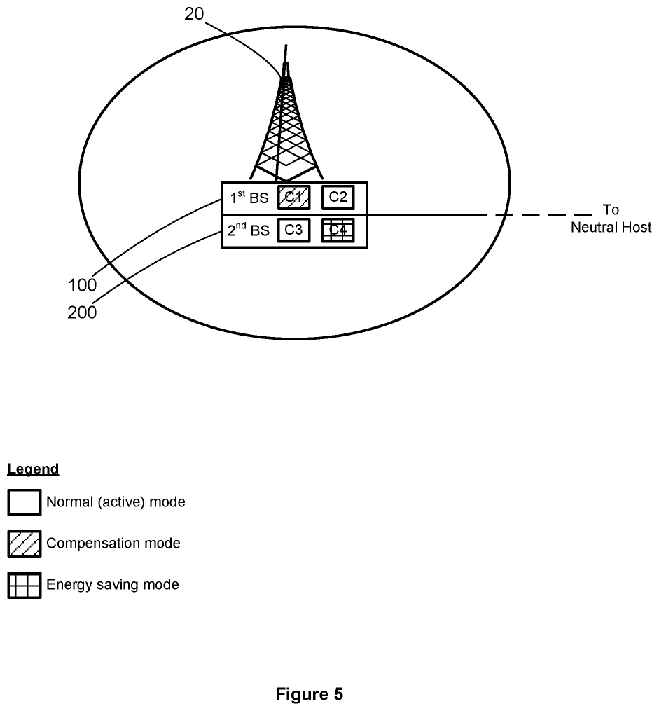

The final state of the cellular telecommunications network is illustrated in FIG. 5.

This embodiment of the present disclosure therefore provides a solution to an increase in demand for capacity (e.g. for higher data rates) by different MNOs sharing their respective carriers in a spectrum sharing solution. Furthermore, this embodiment selects a spectrum sharing solution in which a carrier is switched to energy saving mode, thus reducing energy consumption in the network whilst still satisfying the demand for increased capacity.

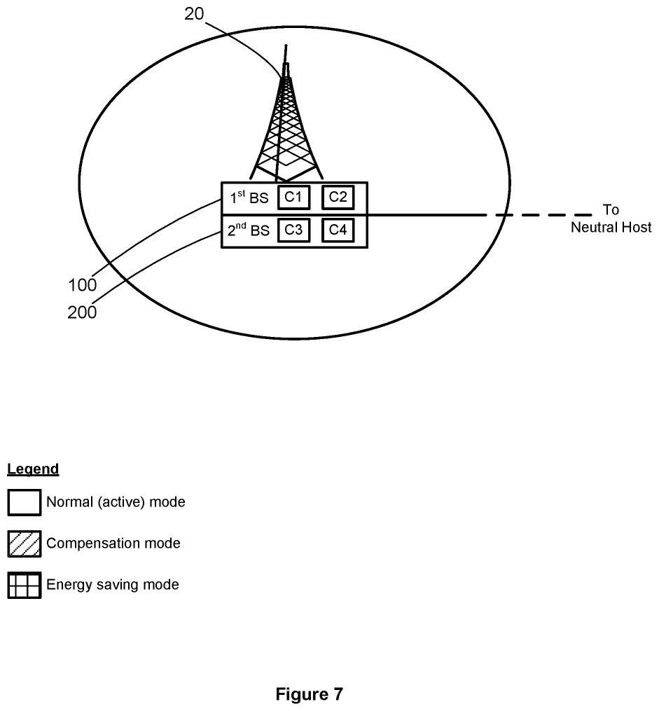

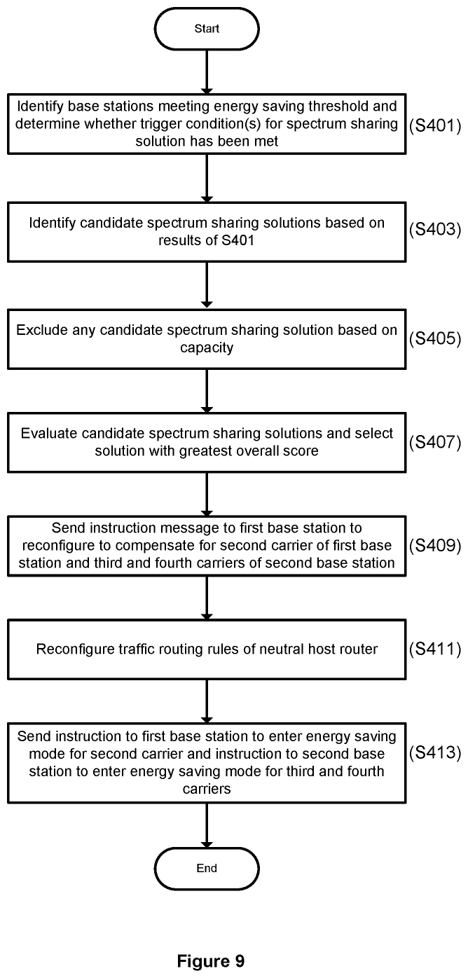

A second embodiment of a method of the present disclosure will now be described with reference to FIGS. 7 to 9. In S401 of this second embodiment, the neutral host controller 42 performs the first process to determine whether the one or more metrics for the first and/or second base station 100, 200 meet a threshold to be identified as an energy saving base station, and to determine whether the one or more metrics for the first and/or second base station 100, 200 meet a threshold for triggering a spectrum sharing solution. In this second embodiment, the most relevant metrics and thresholds for triggering a spectrum sharing solution are the third and fourth options listed above (a load metric meeting a low load threshold indicating that the base station may enter energy saving mode and an energy consumption metric meeting an energy consumption threshold indicating that the base station (or MNO) has consumed too much energy and/or is responsible for too many units of carbon dioxide emissions). The determination may be based on one or both of these metrics, or use weightings to be more heavily influenced by these metrics.

In this example, the neutral host controller 42 determines that a load metric of the second carrier of first base station 100 meets the low load threshold and that a load metric of the third carrier of the second base station 200 meets the low load threshold so as to trigger the second process for identifying a spectrum sharing solution. Furthermore, both the second carrier of the first base station 100 and the third carrier of the second base station 200 are identified for entering energy saving mode.

In S403, the neutral host controller 42 identifies candidate spectrum sharing solutions. These candidate spectrum sharing solutions include any combination of the second carrier of the first base station 100 and the third carrier of the second base station 200 entering energy saving mode, and the first carrier of the first base station 100 and fourth carrier of the second base station 200 being in either energy saving mode, normal (active) mode or compensation mode.

In S405, the neutral host controller 42 evaluates the capacity available for each MNO for each candidate spectrum sharing solution. These capacities are compared to a capacity demand for each MNO (which, unlike the first embodiment, is not an increase above the current capacity availability). If the capacity demand for the first MNO exceeds (or is within a threshold, such as 90%, 95%, 99%) of the capacity available for the first MNO in a candidate spectrum sharing solution (through both exclusive and shared spectrum) and/or the capacity demand for the second MNO exceeds (or is within a threshold, such as 90%, 95%, 99%) of the capacity available for the second MNO in the candidate spectrum sharing solution (through both exclusive and shared spectrum), and/or the additional capacity demand (i.e. the capacity demand above that available through exclusive spectrum) for the first and second MNO exceeds (or is within a threshold, such as 90%, 95%, 99% of) the capacity available for the first and second MNOs through shared spectrum, then that candidate is excluded (and not considered in the remainder of the process). In this example, where the capacity demand is low (and within the capacity availability where all carriers are in normal (active) mode), then the only candidate solutions that are excluded are those where there are no carriers acting for a particular MNO (e.g. both the third and fourth carriers of the second base station 200 are switched to energy saving mode and the first and second carriers of the first base station 100 remain in normal (active) mode and do not share their carriers with the second MNO).

In S407, the neutral host controller 42 performs the second process (as described above with reference to FIG. 3) in which the candidate spectrum sharing solutions are those which are not excluded in S405. In this example where there is a capacity demand for the first and second MNOs is less than the current capacity availability, the overall scores are more heavily influenced (compared to the first embodiment above) by the desirability factor representing the benefits of a carrier entering energy saving mode. In this example, the candidate spectrum sharing solution that receives the greatest overall score involves the second carrier of the first base station 100 and third and fourth carriers of the second base station 200 entering energy saving mode, and the first carrier of the first base station 100 entering compensation mode and compensating for the second carrier of the first base station 100 and third and fourth carriers of the second base station 200.

In S409, the neutral host controller 42 sends an instruction message to the first base station 100 to cause the first base station 100 to reconfigure so that its first carrier compensates for the second carrier of the first base station 100 and third and fourth carriers of the second base station 200. This includes a switch from the MORAN configuration to a MOCN configuration, in which the first base station 100 begins transmitting the first MNO's PLMN identifier (for transmissions between the first base station 100 and UE of the first MNO) and the second MNO's PLMN (for transmissions between the first base station and UE of the second MNO in order to compensate for the second base station's third and fourth carriers). The first base station 100 also accepts handovers and redirections of all users being served by the first base station's second carrier and the second base station's third and fourth carriers.

In S411, the neutral host controller 42 reconfigures the neutral host router so that any traffic for the second MNO's users now being served by the first base station 100 is routed between the first base station 100 and the second MNO's core network.

In S313, the neutral host controller 42 sends an instruction message to the first base station 100 to cause the first base station's second carrier to enter energy saving mode and a further instruction message to the second base station 200 to cause the second base station's third and fourth carriers to enter energy saving mode.

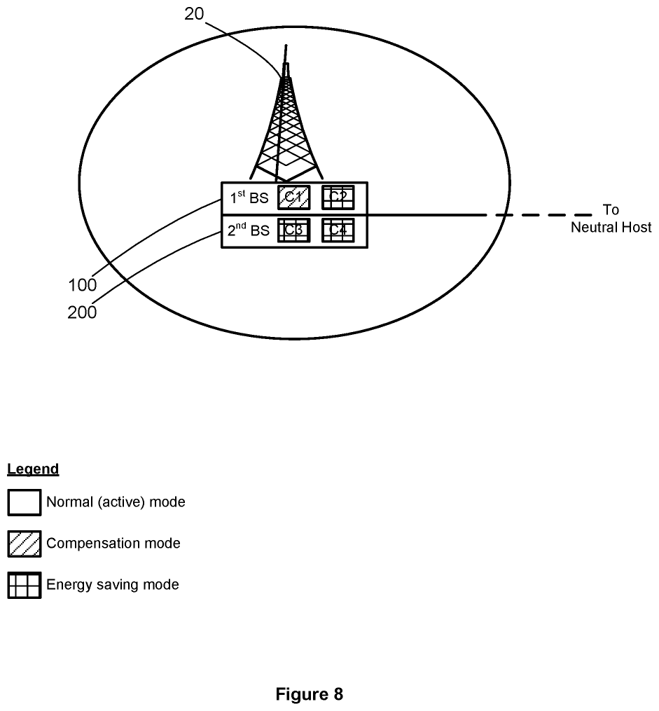

The final state of the cellular telecommunications network is illustrated in FIG. 8.

In an alternative to the second embodiment above, the carriers of the first and second base stations may have relatively high loads but the spectrum sharing solution process is triggered by the energy consumption of the first and/or second base station meeting a threshold. In this alternative example, it is less likely for the carriers to enter energy saving mode (as such solutions may be excluded in S405 or have poor cost factors due to the degraded service).

The skilled person will understand that excluding candidate spectrum sharing solutions may be omitted as a distinct operation and instead implemented by evaluating the cost factor of each solution. Furthermore, the candidate spectrum sharing solution may involve all carriers being in normal (active) mode. This may be the case where the initial state of the network is for one or more carriers to be in energy saving mode, so the candidate spectrum sharing solution is to switch such carriers to normal (active) mode.

The skilled person will also understand that the second base station is non-essential. That is, the first base station 100 may be a multi-carrier base station in which a first carrier is for a first MNO and a second carrier is for a second MNO, and spectrum for the first carrier is shared with the second MNO. The above embodiment therefore illustrates the flexibility of the second process in identifying a solution from a number of candidate energy saving solutions involving multi-carrier base stations.

The skilled person will also understand that the first process may be implemented in the respective base stations, and a message may be sent to the neutral host controller following a trigger condition being met (the base station may also perform its own energy saving solution, such as entering energy saving mode for one of its services, before notifying the neutral host for a network-wide response).

In all embodiments detailed above, there may be a subsequent decision for the base stations to end energy saving mode and switch back to active mode. This may be based on the same triggers used in the first process, or based on independent triggers. Once the base station(s) have returned to active mode, users may be transferred back to the active mode base station, and the compensation mode base station may return to active mode. The neutral host controller and router may also be reconfigured to route user traffic via the user's serving base stations.

Furthermore, the above embodiments may be performed in an iterative manner so that a new spectrum sharing solution may be determined as the most suitable, and the neutral host controller may instruct the relevant base stations to switch to this new spectrum sharing solution.

The skilled person will also understand that it is non-essential for the various processes described above to be performed on the neutral host controller. That is, any entity in the cellular telecommunications network could implement the above processes, and would typically be supported by a sharing arrangement between the operators. Furthermore, it is non-essential for the carriers involved in the spectrum sharing solution to be part of the same base station or same cell site.

In the above embodiments, one of the trigger conditions to initiate the spectrum sharing solution is a count of requests for increased service. This may be, for example, requests requiring greater capacity, or requests for higher peak rates.

The skilled person will understand that any combination of features is possible within the scope of the disclosure, as claimed.

1. A method performed by a network node in a cellular telecommunications network, wherein the cellular telecommunications network includes a first transceiver providing a first access connection in a first spectrum range, and a second transceiver providing a second access connection in a second spectrum range, the method comprising the steps of:
determining that a trigger condition for reconfiguring the second transceiver has been met; and, in response,
evaluating a plurality of candidate transition options, including:
evaluating a first candidate transition option including the steps of:
a) transferring users from the second spectrum range to the first access connection, and
b) following step a), reconfiguring the second transceiver,
wherein the evaluation is based on a user service interruption impact of the first candidate transition option, and
evaluating a second candidate transition option including the steps of:
a) transferring users from the second spectrum range to the first access connection, and
b) following step a), reconfiguring the second transceiver,
wherein the evaluation is based on a user service interruption impact of the second candidate transition option;
selecting a transition option based on the evaluation;
causing the transfer of users from the second spectrum range according to the selected transition option; and
causing the reconfiguration of the second transceiver according to the selected transition option.

2. A method as claimed in claim 1, wherein the first access connection is for a first mobile network operator and the second access connection is for a second mobile network operator, and at least one of the plurality of transition options further includes the steps of:
a) i) reconfiguring the first access connection so that the first spectrum range is for the first and second mobile network operator,
a) ii) following step a) i) transferring users from the second spectrum range to first spectrum range.

3. A method as claimed in claim 1, wherein the first access connection further includes a third spectrum range, and at least one of the plurality of transition options include the step of
a) i) transferring users from the third spectrum range to the first spectrum range,
a) ii) following step a) i) transferring users from the second spectrum range to the first access connection.

4. A method as claimed in claim 3, wherein the first and third spectrum ranges are for the first mobile network operator and second spectrum range is for a second mobile network operator, and step a) i) includes:
a) i) i) transferring users from the third spectrum range to the first spectrum range,
a) i) ii) following step a) i) i), reconfiguring the first access connection so that the third spectrum range is for the second mobile network operator;
and step a) ii) includes transferring users from the second spectrum range to the third spectrum range of the first access connection.

5. A method as claimed in claim 4, wherein step a) i) ii) includes reconfiguring the first access connection so that the third spectrum range is for both the first mobile network operator and the second mobile network operator, and step a) further includes:
a) i) iii) following step a) i) ii), transferring users from the first spectrum range to the third spectrum range,
a) i) iv) following step a) i) iii), reconfiguring the first access connection so that the first spectrum range is for both the first mobile network operator and the second mobile network operator,
wherein step a) ii) includes transferring users from the second spectrum range to the first and third spectrum range of the first access connection.

6. A method as claimed in claim 4, wherein step a) i) ii) includes reconfiguring the first access connection so that the third spectrum range is for both the first mobile network operator and the second mobile network operator, and the method further comprising the steps of:
c) following step b), transferring users from the first spectrum range to the third spectrum range,
d) following step c), reconfiguring the first access connection so that the first spectrum range is for both the first mobile network operator and second mobile network operator,
e) following step d). transferring a subset of users from the third spectrum range to the first spectrum range.

7. A method as claimed in claim 4, wherein step a) i) ii) includes reconfiguring the first access connection so that the third spectrum range is for both the first mobile network operator and the second mobile network operator, and the method further comprising the steps of:
a) iii) following step a) ii), reconfiguring the second access connection so that the second spectrum range is for the first mobile network operator and the second mobile network operator,
a) iv) following step a) iii), transferring users of the first spectrum range to the third spectrum range,
a) v) following step a) iv), reconfiguring the first access connection so that the first spectrum range is for both the first mobile network operator and the second mobile network operator,
a) vi) following step a) v), transferring a subset of users from the third spectrum range to the first spectrum range, and
a) vii) following step a) vi), transferring users of the second spectrum range to the first and/or third spectrum range.

8. A method as claimed in any one of the preceding claims, wherein the trigger condition is that the second transceiver is to enter energy saving mode.

9. A computer program comprising instructions which, when the program is executed by a network node, cause the network node to carry out the steps of any one of claims 1 to 8.

10. A computer readable carrier medium comprising the computer program of claim 9.

11. A network node having a processor configured to carry out the steps of any one of claims 1 to 8.
